(19) United States
(12) Patent Application Publication
(10) Pub. No.: US 2024/0318698 A1
(43) Pub. Date: Sep. 26, 2024

(54) Radial Disc Brake for a Utility Vehicle

(71) Applicant: KNORR-BREMSE Systeme fuer Nutzfahrzeuge GmbH, Muenchen (DE)

(72) Inventors: Martin SCHAUFELBERGER, Straubing (DE); Thomas STEINHUBER, Ortenburg (DE); Daniel KRENN, Neukirchen vorm Wald (DE); Markus MOLNAR, Fuerstenzell (DE)

(21) Appl. No.: 18/694,564

(22) PCT Filed: Sep. 26, 2022
(86) PCT No.: PCT/EP2022/076707

§ 371 Date: Mar. 22, 2024

(30) Foreign Application Priority Data
Sep. 28, 2021 (DE) 10 2021 125 139.7

(51) Int. Cl. F16D 65/40; F16D 55/00; F16D 55/2255; F16D 65/00; F16D 65/18; F16D 125/28

(52) U.S. Cl. CPC F16D 65/40; F16D 55/2255; F16D 65/0068; F16D 65/183; F16D 2055/0016; F16D 2125/28

(57) ABSTRACT

A disc brake for a utility vehicle includes an application device, which is positioned in a receiving space of a brake caliper having a caliper housing and a lever dome arranged thereon. The application device has a pivotable brake lever, which is provided with at least one eccentric portion and a lever arm which adjoins the latter, the lever extending approximately parallel to the axis of rotation of the brake disc and projecting into the lever dome. Two brake plungers are mounted axially adjustably in a bridge and, during braking, lie against a brake pad. A readjustment device compensates for a wear-induced change in an air gap. A synchronizing device is connected functionally to the brake plungers and has a traction mechanism drive. The traction mechanism drive is arranged outside the lever dome, wherein strands of the traction mechanism drive are guided around a partial region of the lever dome.

### BACKGROUND AND SUMMARY

The invention relates to a radial disc brake.

The application device of a radial disc brake of this type conventionally has two brake pistons which are held in a bridge so as to be axially adjustable in a parallel manner at a distance from each other.

A further component of the application device is a brake lever which is pneumatically or electromechanically pivotable and has at least one cam portion for contact with the bridge. On the other side, the brake lever is supported on the brake caliper. The lever arm of the brake lever is housed in a lever dome which is screwed, as a separate part, to a caliper housing of the brake caliper.

The brake pistons are formed as threaded rods with an external thread which engages with the internal thread of a threaded hole in the bridge.

To compensate for a wear-induced change in the distance between the associated brake pad and the brake disc, known as clearance, an adjuster is provided, which adjusts the brake pistons axially by means of rotation.

In order to achieve uniform rotation of the two brake pistons, the adjuster has a synchronization device which causes both brake pistons to advance uniformly so that uneven wear of the brake pads is avoided.

In the known radial disc brakes, the synchronization device is configured as a traction mechanism drive, predominantly in the form of a chain drive, wherein the two strands, which are deflected on sprockets of the brake pistons, extend in a substantially linear manner. The traction mechanism drive may consist of a roller link chain, but other traction mechanisms, for example toothed belts, are also contemplated.

Due to this design, the lever is guided around the chain drive, and it is consequently necessary for the brake caliper to be formed in a plurality of parts, wherein the lever dome accommodating the lever arm of the brake lever is connected to the caliper housing as a separate part, which is conventionally made of cast iron, as is the brake caliper as a whole.

The disadvantage of this is that, alongside the use of a plurality of screws for connection purposes, sealing measures are in particular also required to protect the interior of the brake caliper.

Process variations, such as those which arise when the disc brake is put together, in this case in particular when the lever dome is fastened to the caliper housing, are disadvantageous, as is the relatively high weight of the brake caliper, which results from the construction thereof and conflicts with ongoing requirements to minimize weight.

The invention is based on the object of further developing a radial disc brake of the type in question in such a way that it can be produced relatively rapidly and thus more cost-effectively with means which are simple in design, and the operational reliability thereof is improved.

This object is achieved by a radial disc brake with the features of the independent claims.

According to the invention, guiding the strands outside the lever dome, into which the lever arm of the brake lever projects, makes it possible to form the lever dome and the caliper housing as a one-piece cast part.

This significantly simplifies the work involved in assembly, i.e., putting together the disc brake, since it is no longer necessary to connect a separate lever dome to the caliper housing.

The machining of the parts forming the brake caliper, that is to say the caliper housing and the lever dome, is also simplified and thus more cost-effective, wherein in particular it is no longer necessary to form threaded holes in the caliper housing in order to connect the lever dome to the caliper housing, as in the prior art.

Assembly is also simplified owing to the fact that it is no longer necessary to provide or install a seal, as is required when the brake caliper is formed in a plurality of parts.

Moreover, the invention reduces the weight of the disc brake, in particular the brake caliper, and thus satisfies the requirements for weight optimization to a considerable extent. Since a plurality of disc brakes are used in utility vehicles, in particular multi-axle vehicles, weight reduction is of particular importance, as this also reduces fuel consumption.

As has been shown, brake piston synchronization, and consequently braking performance, are improved.

Since the traction mechanism drive according to the invention is arranged outside the lever dome, altering the chain slack is less difficult than was previously the case.

In one configuration variant of the invention, the strands are guided via deflection pins which are set in a flange face of the brake caliper, wherein the chain slack can be altered if necessary by adding or removing spacer sleeves on a deflection pin or by rotating at least one arranged cam.

Preferably, the strands are guided around the lever dome in a notional approximately U-shaped or trapezoidal path, wherein the cam contacts the strand located in an outer position relative to the lever dome, while the inner strand contacts the spacer sleeves.

According to a further concept of the invention, guides, which are arranged in a U-shape around the lever dome and on which the strands are supported, are provided for guiding the strands.

These guides are preferably formed from sheet metal, wherein an inner guide is rigidly connected to the brake caliper, while the outer guide is adjustably fastened to the brake caliper, specifically in such a way that the chain slack can be altered by shifting the guide in the vertical direction.

The guides are fixed to the brake caliper by a screw connection. Alternatively or in addition, the guides may also be held on the brake caliper by a form fit.

In contrast to the aforementioned variant, in another configuration of the invention, the strands are guided by a carrier plate which is fastened to the brake caliper and has a support collar on which the inner strand is supported, i.e., on which the inner strand is guided.

The outer strand is in contrast guided via two opposing guide levers, at least one of which can be pivoted in the manner of a tension lever in order to influence the chain slack. For this purpose, the guide lever is mounted on one side on a fastening bolt and on the other side can be pivoted along a slot through which a screw passes, with which the guide lever can be secured in the desired position.

To protect the traction mechanism drive, a cover plate is provided which covers the traction mechanism drive and is connected to the flange face of the brake caliper by Vern. To adjust the traction mechanism drive or the strands, it is necessary merely to remove the cover plate to allow free access to the traction mechanism drive.

Further advantageous configurations of the invention are set out in the dependent claims.

Exemplary embodiments of the invention are described below with reference to the appended drawings.

### BRIEF DESCRIPTION OF THE DRAWINGS

FIGS. 1 and 2 are perspective views of a disc brake according to the prior art, each in different assembly positions;

FIGS. 3 and 4 are diagrams of a disc brake according to an embodiment of the invention, also in different assembly positions; and

FIGS. 5 and 6 each show a perspective view of a further configuration variant of a disc brake according to the invention.

### DETAILED DESCRIPTION OF THE DRAWINGS

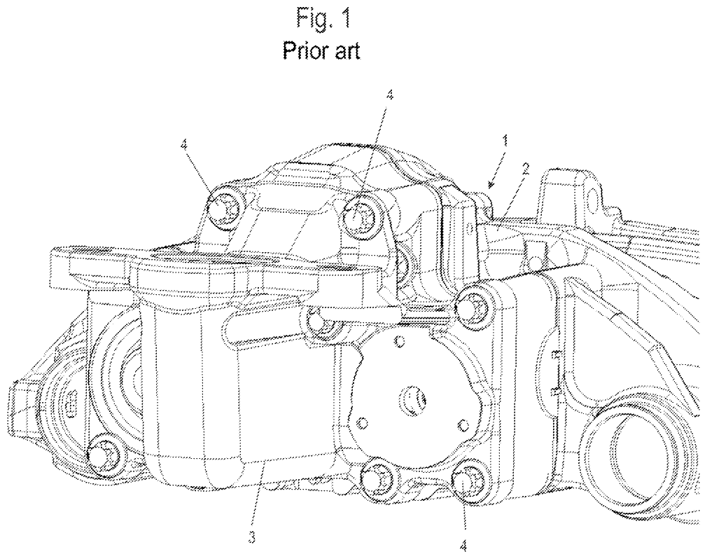

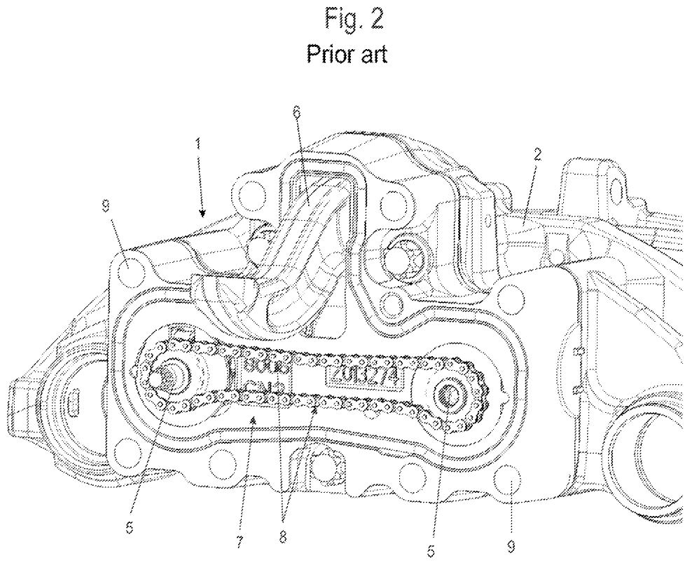

FIG. 1 depicts a brake caliper 1 of a disc brake for a utility vehicle according to the prior art, the brake caliper having a caliper housing 2 and a lever dome 3 fastened thereto by means of screws 4. While FIG. 1 shows the brake caliper 1 in the complete form thereof, FIG. 2 shows the caliper housing 2 without the lever dome 3 attached.

FIG. 2 shows that a traction mechanism drive 7, which in this example consists of a roller-link chain, has two strands 8, which are guided in a linear manner, extend parallel to each other and engage in sprockets 5 of an adjuster. The sprockets 5 are connected to brake pistons (not shown) by means of which a brake pad (also not shown) can be pressed against a brake disc.

The traction mechanism drive 7 is arranged on the exterior of the caliper housing 2 and is positioned beneath the lever arm 6 of a brake lever. When the disc brake is complete, as depicted in FIG. 1, the lever dome 3 covers the traction mechanism drive 7, wherein the lever arm 6 projects into the lever dome 3.

FIG. 2 further shows threaded holes 9, which are formed in the caliper housing 2 and into which the screws 4 for fastening the lever dome 3 to the caliper housing 2 are screwed.

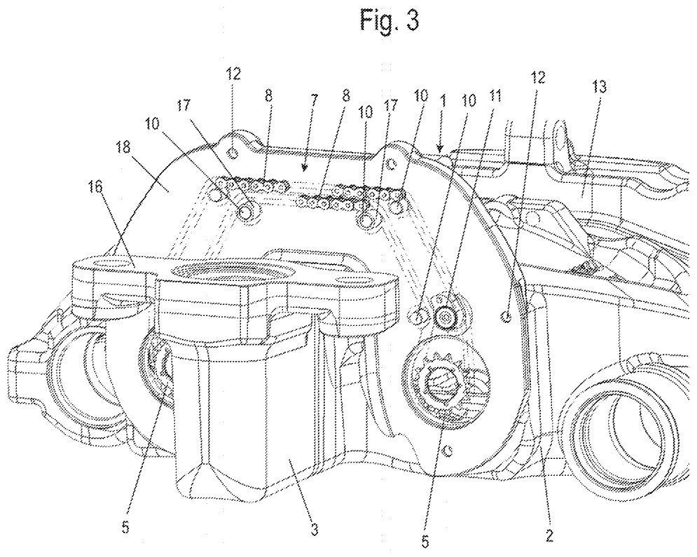

FIG. 3 shows a disc brake according to the invention, in which the traction mechanism drive 7 is guided outside the lever dome 3, which is formed in one piece with the caliper housing 2, wherein the substantially parallel course of the two strands 8 is approximately U-shaped or trapezoidal.

To guide the strands 8, deflection pins 10 are arranged on a flange face 18 of the caliper housing 2, wherein a horizontal course of the strands 8 extends on the upper horizontal plane associated with a bearing surface 16 of the lever dome 3 for a pneumatic cylinder. The bearing surface 16 is moreover on the same side of the brake caliper as an assembly opening 13 of the caliper housing 2.

As also shown in FIG. 3, some of the deflection pins 10 are provided with spacer sleeves 17, by means of which the chain slack can be altered if necessary, wherein these spacer sleeves 17 are arranged on the deflection pins 10, which are in contact with the lower strand 8 facing the lever dome 3.

In addition or alternatively, the upper strand 8 is guided on a pivotable cam 11 which, depending on the adjustment, can likewise alter the chain slack, wherein the cam 11 may also act to deflect the contacting strand 8. A deflection pin 10 with a fitted spacer sleeve 17 may also be provided rather than the cam 11.

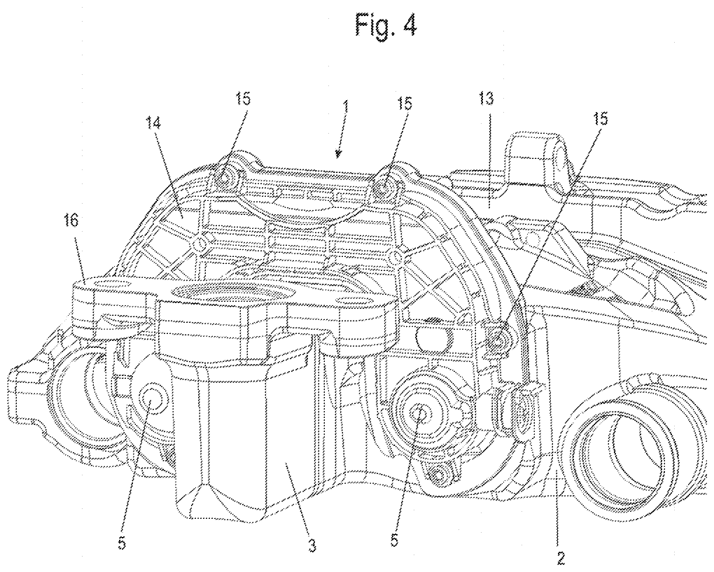

In FIG. 4, the disc brake is shown in the complete form thereof, in so far as the traction mechanism drive 7 is covered by a cover plate 14, wherein this cover plate 14 is screwed by means of screws 15 into threaded holes 12 (FIG. 3) in the flange face 18. Preferably, the contour of the cover plate 14 corresponds to that of the flange face 18.

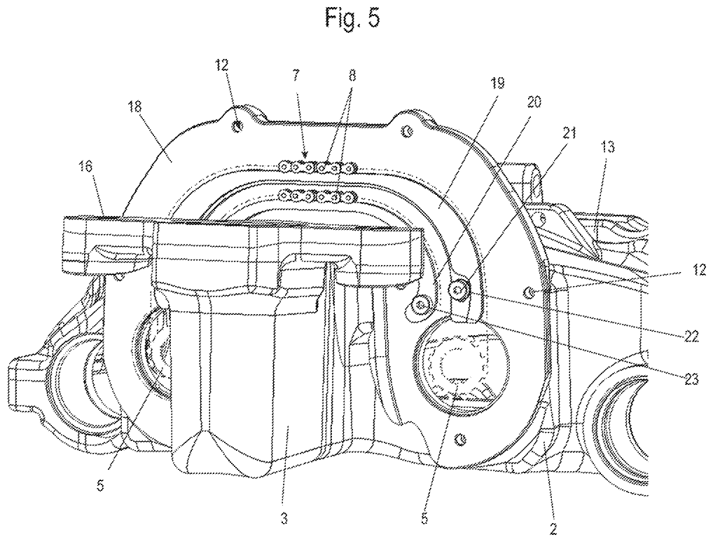

A further configuration variant of the disc brake according to the invention is depicted in FIG. 5. In this case, an outer guide 19 and an inner guide 20 are provided as separate parts for directing the strands 8 of the traction mechanism drive 7, the guides being formed so as to be bow-shaped and each being in contact with a strand 8, specifically on the side of the respective guide 19, 20 remote from the bearing surface 16.

The inner guide 20, which is located closer to the lever dome 3, is rigidly connected to the brake caliper 1 by screws, the screws 23 being screwed into the flange face 18.

The outer guide 19 is likewise connected to the flange face 18, but in such a way that it can be pivoted to a certain extent if necessary to adjust the tension of the chain. For this purpose, a fastening screw 21 is guided in a slot 22 of the outer guide 19 so that the guide 19 can be moved in a vertical direction. After it has been altered appropriately, the outer guide 19 can be fixed by tightening the fastening screw 21.

The guides 19, 20 may be formed as shaped sheet metal parts, wherein at the exterior the latter form a bearing surface for the strands 8 with a bow-like, i.e., U-shaped, course.

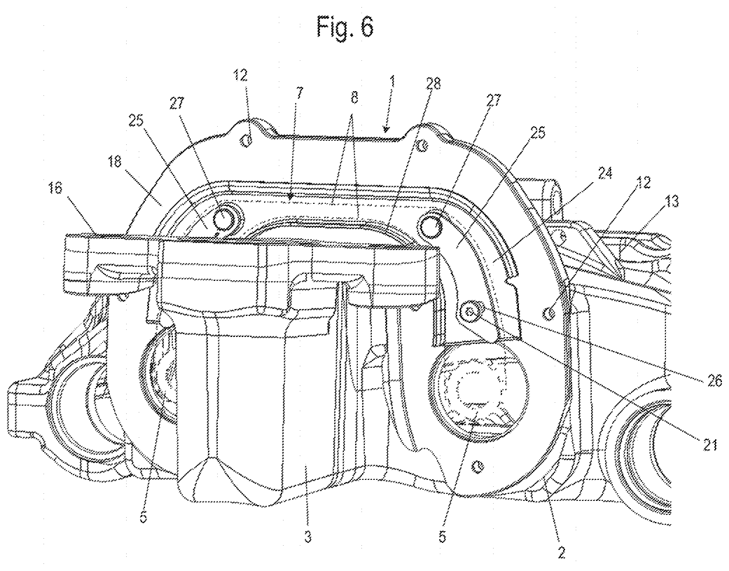

FIG. 6 shows a further configuration of the invention, in which a carrier plate 24 is connected to the brake caliper 1 for guiding the traction mechanism drive 7. Fastening bolts 27 and fastening screws 21 are provided for connection purposes.

The strand 8, located in an inner position relative to the lever dome 3, is guided on an integrally formed support collar 28, which extends in a U-shape. In contrast, the outer strand 8 contacts guide levers 25, at least one of which is pivotable about the fastening bolt 27 which fastens the guide lever 25 and thus the carrier plate 24 to the brake caliper 1.

The outer strand 8 can be tensioned if necessary by pivoting the guide lever 25. For this purpose, the fastening screw 21 is guided in a slot 26 provided in the guide lever 25. As in the example shown in FIG. 5, the guide lever 25 is fixed by tightening the fastening screw 21 after the outer strand 8 has been tensioned.

The carrier plate 24 is likewise shaped in a forming process to achieve a bow-like, U-shaped form.

### LIST OF REFERENCE SIGNS

1 brake caliper
2 caliper housing
3 lever dome
4 screw
5 sprocket
6 lever arm
7 traction mechanism device
8 strand
9 threaded hole
10 deflection pin
11 cam
12 threaded hole
13 assembly opening
14 cover plate
15 screw
16 bearing surface
17 spacer sleeve
18 flange face
19 guide
20 guide
21 fastening screw
22 slot
23 screw
24 carrier plate
25 guide lever
26 slot
27 fastening bolt
28 support collar

1.-18. (canceled)

19. A disc brake for a utility vehicle, comprising:
a brake caliper comprising a caliper housing and a radial lever dome arranged thereon, a receiving chamber being formed in the caliper;
an application device positioned in the receiving chamber, the application device comprising:
a pivotable brake lever which is provided with at least one cam portion and an adjoining lever arm which extends approximately parallel to an axis of rotation of the brake disc and projects into the lever dome,
two brake pistons which are mounted so as to be axially adjustable in a bridge, and contact a brake pad during braking,
an adjuster for compensating a wear-induced change in clearance, and
a synchronization device which is functionally connected to the brake pistons and comprises a traction mechanism drive,
wherein the traction mechanism drive of the synchronization device is arranged outside the lever dome, and
wherein strands of the traction mechanism drive are guided around a portion of the lever dome.

20. The disc brake as claimed in claim 19, wherein
the strands contact deflection pins.

21. The disc brake as claimed in claim 19, wherein
the strands extend along a notional U-shaped or trapezoidal path.

22. The disc brake as claimed in claim 20, wherein
at least one of the deflection pins is provided with a spacer sleeve for altering any slack in the strands.

23. The disc brake as claimed in claim 22, wherein
the spacer sleeve is arranged on a strand facing the lever dome.

24. The disc brake as claimed in claim 19, wherein
at least one pivotable cam is provided for altering any slack in the strands.

25. The disc brake as claimed in claim 24, wherein
the pivotable cam is arranged on a deflection pin.

26. The disc brake as claimed in claim 24, wherein
the pivotable cam contacts a strand remote from the lever dome.

27. The disc brake as claimed in claim 20, wherein
the deflection pins are fastened to a flange face of the caliper housing.

28. The disc brake as claimed in claim 27, wherein
the traction mechanism drive is covered by a cover plate which is connected to the flange face.

29. The disc brake as claimed in claim 28, wherein
a contour of the cover plate corresponds to a contour of the flange face.

30. The disc brake as claimed in claim 19, wherein
the strands of the traction mechanism drive are each guided via a guide, the respective guides being formed so as to be bow-shaped and being connected to the brake caliper.

31. The disc brake as claimed in claim 30, wherein
an outer one of the guides is pivotably fastened to the flange face, wherein a fastening screw is held in a slot of the outer guide.

32. The disc brake as claimed in claim 30, wherein
at an exterior, the guides have a contact surface for the strands.

33. The disc brake as claimed in claim 19, wherein
a carrier plate is fastened to a flange face of the caliper, wherein guide levers, which are in contact with an outer one of the strands, are arranged on the carrier plate for guiding the outer strand.

34. The disc brake as claimed in claim 33, wherein
a support collar is arranged on the carrier plate for guiding an inner one of the strands.

35. The disc brake as claimed in claim 33, wherein
at least one of the guide levers is pivotably fastened to the carrier plate.

36. The disc brake as claimed in claim 35, wherein
the pivotable guide lever has a slot through which a fastening screw is guided.
